(19) United States
(12) Patent Application Publication
(10) Pub. No.: US 2013/0282497 A1
(43) Pub. Date: Oct. 24, 2013

(54) ASSIGNING AN ADVERTISEMENT

(71) Applicants: George H. Forman, Port Orchard, WA (US); William G. Horne, Lawrenceville, NJ (US); Pratyusa Kumar Manadhata, Placataway, NJ (US)

(72) Inventors: George H. Forman, Port Orchard, WA (US); William G. Horne, Lawrenceville, NJ (US); Pratyusa Kumar Manadhata, Placataway, NJ (US)

(21) Appl. No.: 13/453,842

(22) Filed: Apr. 23, 2012

(51) Int. Cl. G06Q 30/02

(52) U.S. Cl. 705/14.73

(57) ABSTRACT

Methods, systems, and computer-readable and executable instructions are provided for assigning an advertisement. Assigning an advertisement can include constructing a graph of events between a number of visitors and a number of domains, iteratively calculating a set of domain scores for the advertisement using a spreading function on the graph, and assigning the advertisement to a domain based on a domain score of the domain, wherein the domain score is among the set of domain scores.

### BACKGROUND

An increasing use of the Internet by consumers has made the Internet a growing frontier for advertising. Internet domains receiving large quantities of visitors are proving to be viable advertising platforms. Advertisements on Internet domains can include banner ads, sky-scraper ads, and other interactive ads that can provide the domain with a revenue stream and provide access to the advertisers' products for consumers.

### BRIEF DESCRIPTION OF THE DRAWINGS

FIG. 1 is a flow chart illustrating an example of a method for assigning an advertisement according to the present disclosure.

FIG. 2 illustrates an example of a visitor domain graph according to the present disclosure.

FIG. 3 is a block diagram illustrating an example of a process for assigning an advertisement according to the present disclosure.

FIG. 4 is a block diagram illustrating a processing resource, a memory resource, and a computer readable medium according to the present disclosure.

### DETAILED DESCRIPTION

With the advent of personal computers (PCs), tablets, netbooks, and smart phones, an increasing use of the Internet by consumers (e.g., customers) for various tasks may develop. As a result, advertisers may desire to utilize the Internet as a frontier for advertising to consumers. Advertisers can seek to target their advertisement to consumers likely to consume their products by selecting domains on which to present the Internet advertisement. A number of companies have begun providing a service of determining a targeted audience to display an advertisement on the Internet to, often called an ad network. Ad networks can determine an advertisement to display on a domain by associating keywords with the advertisement and placing the advertisement on a page that has the best match to the associated keywords. An ad network may help an advertiser determine appropriate keywords to associate with an advertisement in order to have the greatest chance of having the advertisement seen by potential customers. The advertiser then typically bids money for the potential keywords.

Using keywords can present numerous problems for an advertiser. An analysis of potential keywords for an advertisement by an ad network may result in pages of keyword suggestions. An advertiser may have little ability to determine which of the suggested keywords to bid on. An advertiser may further be forced to determine new keywords for each new advertisement created, costing large amounts of money. In addition, bidding for the keywords has little connection to the advertiser's desired results of paying more money for the location of an advertisement that will be more likely to result in a purchase of a product. In contrast, some examples of the present disclosure do not require keywords for assigning an advertisement to a domain.

Examples of the present disclosure include methods, systems, and computer-readable medium storing a set of instructions to assign an advertisement. A method for assigning an advertisement can include constructing a graph of events between a number of visitors and a number of domains, iteratively calculating a set of domain scores for the advertisement using a spreading function on the graph, and assigning the advertisement to a domain based on a domain score of the domain, wherein the domain score is among the set of domain scores.

In the present disclosure, reference is made to the accompanying drawings that form a part hereof, and in which is shown by way of illustration how a number of examples of the disclosure can be practiced. These examples are described in sufficient detail to enable those of ordinary skill in the art to practice the examples of this disclosure, and it is to be understood that other examples can be used and that process, electrical, and/or structural changes can be made without departing from the scope of the present disclosure.

The figures herein follow a numbering convention in which the first digit corresponds to the drawing figure number and the remaining digits identify an element or component in the drawing. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense. Also, as used herein, “a number of” a element and/or feature can refer to one or more of such elements and/or features.

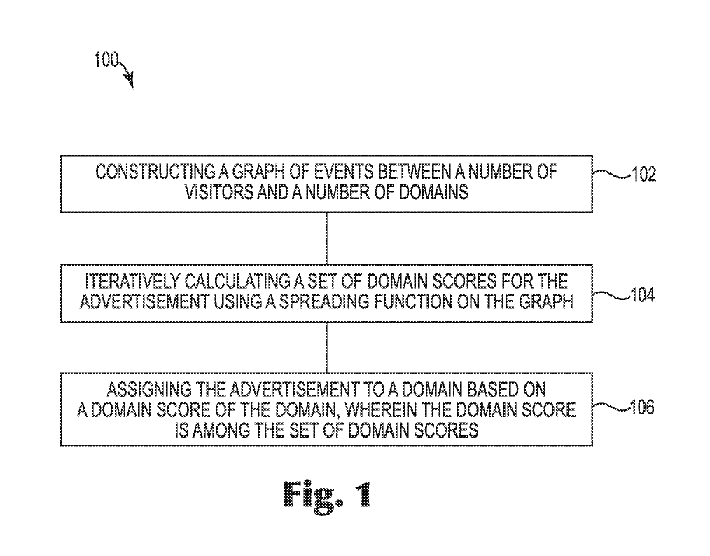

FIG. 1 is a flow chart illustrating an example of a method 100 for assigning an advertisement according to the present disclosure.

At 102, a graph of events between a number of visitors and a number of domains can be constructed. The events can include visits to the number of domains by the number of visitors, for example. The number of visitors can include a number of users connected to the Internet or World Wide Web. A visitor can be connected to the Internet through a server or directly. A visitor may be identified by the device (e.g., machine and computer) that the visitor connects to the Internet with, for example, by the IP address of the visitor. The number of visitors can visit a domain among the number of domains by connecting to the domain via a server and/or the Internet. The number of domains can include top-level domains, or could be finer-grained such as individual website pages within a domain, for example. For instance, the number of domains can include domains relating to the Internet, television, newspapers, catalogs, articles, among many others.

For example, the method 100 can include receiving event logs containing the events between the number of visitors and the number domains. The event logs can include browsing logs and list of domains visited by the number of visitors, for example. The event logs can be received from a provider, a telecom operator, and/or be internal to a database, for example. For instance, the event logs can be received in real time as the browsing occurs (e.g. a live event log).

The event logs can contain information about the activity of the number of visitors. The event logs can be maintained on a number of servers and/or on computing device of the visitor, among other locations. An event log can include hypertext transfer protocol (HTTP) logs, domain name system (DNS) logs, and/or dynamic host configuration protocol (DHCP) logs, among others. Information from such event logs can be used to construct a graph (e.g., a bipartite graph).

The graph constructed can include a bipartite graph and a visitor domain graph, for instance. A bipartite graph constructed may consist of two sets of nodes: one set of nodes representing a number of visitors and one set of nodes representing a number of domains. The number of nodes representing the number of visitors and the number of domains can be connected by a number of edges. For example, an edge may exist between a visitor node and a domain node if the event logs can be used to show that the corresponding visitor visited the correspond domain.

In some examples of the present disclosure, a first prior can be assigned to each of the number of domains and a second prior can be assigned to each of the number of visitors for an advertisement. A prior can include a numerical value that represents the visitor's and/or domain's affinity for an advertisement, for example. In other words, a prior can include an initial estimate of the reputation of the visitor and/or domain. Priors assigned can be used to calculate a score for each of the number of visitors and each of the number of domains.

For example, a first prior can include a numerical value that is assigned based on external information to the event logs and the second prior can include a default numerical value. In such an example, a first prior assigned to a first domain may be higher than a first prior assigned to a second domain in response to the first domain being associated to the advertisement. A first domain may be associated to the advertisement in response to the advertiser providing an initial list of domains that are related to the advertisement, and in response to external information indicating the first domain is related in subject matter to the advertisement, for example.

A default numerical prior value can include a value that may be considered low (e.g., 0.01) that is assigned to all of the number of visitors and/or a functions of the visitor's attribute. An attribute of a visitor can include the degree of the visitor (e.g., number of edges) in the graph (e.g., a visitor with a large degree can indicate a popularity such as a number of visits made from the visitor), a frequency of the visitor in the event dataset (e.g. a visitor with a greater frequency in the dataset can indicate that the visitor accessed more often), or a number of HTTP requests made by the visitor.

In another example, a first prior can include a default numerical value and the second prior can include a numerical value that is assigned based on external information to the event logs. In such an example, a second prior assigned to a first visitor can be a higher numerical value than a second prior assigned to a second visitor, in response to the first visitor being associated to the advertisement. A first visitor may be associated with the advertisement if the first visitor has previously purchased a product from the advertiser and/or if the first visitor is geographically located near a location, for example. A first visitor associated with the advertisement may be assigned a unique visitor identification (ID), for instance. The visitor ID can be used to store the associated high prior of the first visitor for use when the first visitor's activities are identified in future event logs.

At 104, a set of domain scores for the advertisement can be iteratively calculated using a spreading function on the graph. A spreading function can include estimating the state of behavior of a node of the graph based on states of behavior assumed by other graph nodes. The spreading function can include a belief propagation function, for example. A belief propagation function can apply marginal probability estimation to the graph. The spreading function can result in a score for each of the number of visitors and each of the number of domains from the event logs received. The set of domains scores, for instance, can include the set of scores for each of the number of domains and the set of scores for the number of domains and the number of visitors, for example.

Iteratively calculating can include applying the spreading function to the graph, where, in each iteration, messages are passed over the edges connecting a visitor to a domain. A belief can be computed whether the number of visitors and the number of domains may have or are likely to have an affinity toward the advertisement. For example, a first domain and/or first visitor with a score that is higher than a second domain and/or second visitor may be more likely to be interested in and/or relate to the advertisement than the second domain and/or second visitor.

In various examples of the present disclosure, the calculated set of domain scores for the advertisement can be provided to an advertiser. The advertiser can include a creator of the advertisement, a seller of the product in the advertisement, and the marketing team of the advertisement, among others. A domain score among the set of domain scores can be changed in response to an indication from the advertiser. An indication can include the advertiser selecting the domain, the advertiser providing a list of domains, and the advertiser indicating to an ad network to change the domain score, among others. The score for the domain can be increased (e.g., raised) or decreased (e.g., lowered), for example. For instance, an advertiser may raise the score of a first domain based on the first domain being associated with the advertisement and the advertiser may lower the score of a second domain based on the second domain being unrelated to the advertisement.

In response to a score for a domain among the set of domain scores changing, the set of scores for the advertisement can be recalculating using the spreading function on the graph. Recalculating the scores can include recalculating the set of domain scores for the advertisement and/or recalculating the set of visitor scores for the advertisement, for example.

At 106, the advertisement can be assigned to a domain based on a domain score of the domain, wherein the domain score is among the set of domain scores. For example, the advertisement can be assigned to a number of the domains based the domain score of the number of domains. The assignment of the advertisement to a domain can be based on the domain having the largest score among the number of domains, the domain having the largest product of a score and a bid-price, the domain having the largest score among a advertisement class, and an estimated click-through-rate of the advertisement, for example.

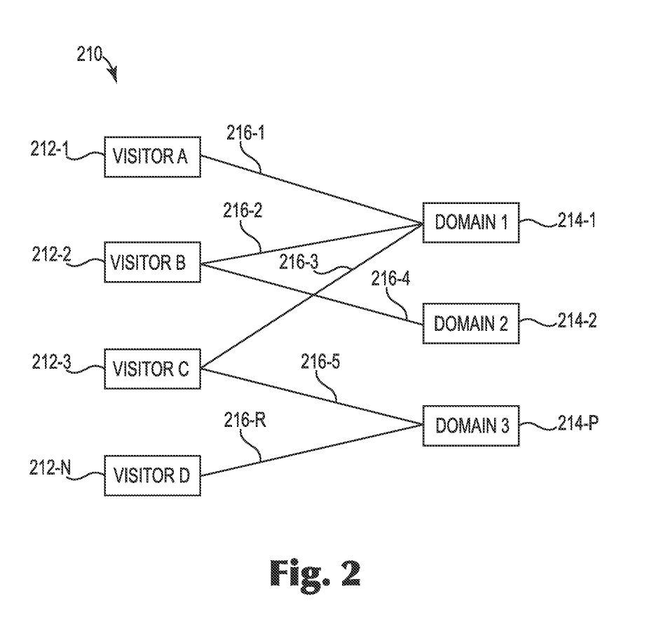

FIG. 2 illustrates an example of a visitor domain graph 210 according to the present disclosure. A visitor domain graph 210 can include a graph, for example. The visitor domain graph 210 is a graphical representation of information of the domains visited (or attempted to be visited) by the visitors. However, “constructing a graph,” as used herein, does not require that a physical or graphical representation of the information actually exists. Rather, such a graph 210 can be represented as a data structure in a tangible medium (e.g., in memory of a computing device). Nevertheless, reference and discussion herein may be made to the graphical representation, which can help the reader to visualize and understand a number of examples of the present disclosure.

The visitor domain graph 210 includes a number of visitors 212-1, 212-2, 212-3 . . . 212-N (generally 212) and a number of domains 214-1, 214-2 . . . 214-P (generally 214). The visitors 212 and the domains 214 are collectively referred to as nodes of the graph 210. The visitors 212 and the domains 204 can each be unique (e.g., the graph 210 does not include more than one entry per visitor 212 or domain 214). The visitor domain graph 210 can include a number of edges 216-1, 216-2, 216-3, 216-4, 216-5 . . . 216-R (generally 216). An edge 216 can represents a visit of a domain 214 by a visitor 212. For example, the edge 216-1 represents a visit by the visitor 212-1 to the domain 214-1. Such a graph 210 may have overlaps between different visitors 212 and domains 214 (e.g., both the visitor 212-1 and the visitor 212-2 visit the domain 214-1). The order in which a visitor 212 visits various domains 214 may be irrelevant to the graph 210.

The visitor domain graph 210 illustrated in FIG. 2 may be a scaled down version of what an actual graph might look like in practice. For example, a visitor domain graph 210 can be generated based on HTTP logs, HTTP proxy servers, and DHCP logs. The graph can include millions of nodes and millions of edges, for example. An HTTP log can identify which uniform resource locators (URLs) are visited by a visitor (represented through an IP address). A domain 214 can be identified via the URL. Because IP addresses may churn due to dynamic addressing, the DHCP logs can be used to more accurately associate a visitor 212 with a domain 214 because the DHCP logs can help identify the IP address(es) bound to a visitor over the duration of the analysis. Each visitor 212 can be uniquely identified by a media access controller (MAC) address of its network interface. Thus, the graph 210 can represent a network interface as a visitor 212 node.

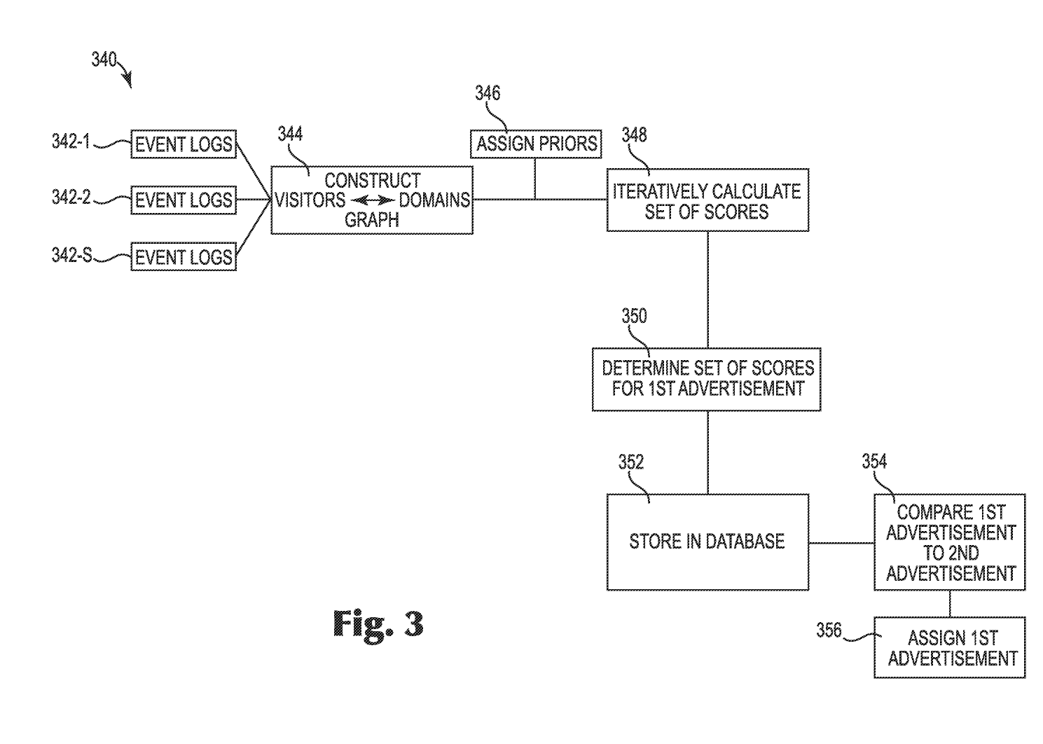

FIG. 3 is a block diagram illustrating an example of a process 340 for assigning an advertisement according to the present disclosure.

An event dataset can be collected from event logs 342-1, 342-2 . . . 342-S received. The event logs can include visits to a number of domains by a number of visitors. As illustrated at 344, and as described with respect to FIG. 2, the process 340 can include constructing a graph including a number of nodes representing the number of visitors and the number of domains connected by a number of edges. Each edge can connect a respective one of the visitors to one of the domains, for example. The graph is described in more detail with respect to FIG. 2.

At 346, the process 340 can include assigning a prior to each of the number of nodes for an advertisement. An advertisement can include a first advertisement, for example. The prior assigned to each of the number of nodes can include a default numerical value or a numerical value assigned based on information external to the event logs that indicate an initial likelihood that the node is associated with the advertisement. Information external to the event logs can refer to information about nodes that was obtained based on observation rather than based on a probabilistic determination. For example, information external to the event logs for a node can include a list of initial domains received from an advertiser indicating the initial domains are associated with the advertisement, a list of domains automatically added in response to a query of the advertisement, and a list of visitors that have previously purchased a product from the advertiser, among others.

In some examples of the present disclosure, assigning priors to the number of nodes can include assigning a default numerical value. The default numerical value can be a constant value indicating a low affinity (e.g., small affinity, 0.01, and lower value compared to a node that is known to be related to the advertisement) for the advertisement, or the default value can include a value determined by a function (e.g., an increasing and/or decreasing sigmoid function) that varies according to the attribute of the node. The attribute of the node can be a degree of the node in the graph, a frequency of the node in the event logs 442-1, 442-2 . . . 442-S, or a number of HTTP requests made by or from the node.

The function can include a sigmoid function. For example, the equation:

$$f ( x ) = \frac{1}{1 + {e}^{\frac{- ( x - k )}{W}}} \\ where , \\ 0 \leq f ( x ) \leq 1 \qquad ( 1 )$$

where f(x)=0.5 when x=k. W, the sigmoid width, is a parameter that defines the slope or the rate of increase or decrease of f(x). The sigmoid function can be monotonically increasing or decreasing depending upon the coefficient for (x−k) in equation (1). For example, if the coefficient is negative, f(x) is monotonically increasing and decreasing otherwise.

For example, an increasing sigmoid function can be used to assign priors for unknown visitor nodes (e.g., where the prior is a function of the number of HTTP requests). An assumption can be made that an increased number of HTTP requests indicates an increased affinity for the advertisement. The parameter k for the visitor prior function can be an average number of HTTP requests made by visitor nodes (e.g., 6219).

In some examples, a decreasing sigmoid function can be used to assign priors for unknown domain nodes where the function can vary with the degree of the node. A node with a large degree (e.g., a first node with a larger number of edges than a second node) indicates higher popularity than a node with a smaller degree (e.g., second node with a smaller number of edges) and thus the function can assign a high prior to the node (e.g., a first node with a larger degree can be assigned a higher prior than a second node with a smaller degree).

Using constant priors for unknown nodes may perform marginally better for lower false positive rates (e.g., falsely identifying a node as having an affinity toward the advertisement). However, the number of iterations (or the time taken) to converge to final belief values may be less (e.g., half) for sigmoid based priors with a similar performance.

In various examples of the present disclosure a pseudo-domain node can be added to the graph. The pseudo-domain node can include a distance from a location. A location can include a location of a store, a promotional location, a location of the advertiser's property, among many others. A prior can be assigned to the pseudo-domain node representing an initial likelihood that the pseudo-domain node is associated with the advertisement (e.g., a value of 0.99 and a higher prior value than a default value assigned to an unknown domain). The pseudo-domain node can be connected to a visitor node among the number of visitor nodes with an edge in response to the visitor being within a threshold distance from the location. For example, a threshold distance can include a geographically close location to the advertiser (e.g. 100 feet, 10 yards, 1 mile, etc.).

At 348, the process 340 can include iteratively calculating a set of visitor scores and domain scores for the advertisement using a spreading function. The spreading function can include a belief propagation function for marginal probability estimation, for example. Belief propagation for marginal probability estimation can include the use of the priors, which are an initial estimate of the reputation of each node. Belief propagation can also include the use of edge potentials, which define the relationship between two nodes connected by an edge.

A spreading function in a graph G=(V, E) with V nodes and E edges, can include estimating the state of behavior of a node based on states of behavior assumed by other graph nodes. The marginal probability estimation problem is NP-Complete. That is, for large graphs, the computation time can increase exponentially with increasing number of nodes. A spreading function can be a relatively fast approach for computing the marginal probability.

Given a set of random variables, belief propagation can be used for estimating the marginal probability for a variable. The goal generally may be to infer a graph node's state of behavior. Random variables in the context of assigning an advertisement can include unknown domains and unknown visitors, for example. To elaborate, given a graph with random variables as nodes with an initial state of behavior distribution, and the relationship between nodes defined by a pre-determined criteria, belief propagation can help infer the probability (or the belief) of a node to be in a particular state of behavior. Belief propagation can compute the marginal probabilities based on messages passed between nodes over multiple iterations. The iterations may be repeated until the system converges to a stable probability distribution of the states of behavior for each node.

The probability of a node i being in a state of behavior xᵢ, is referred to as the belief, denoted by bᵢ(xᵢ). The computation of bᵢ(xᵢ) may involve two factors: the initial probability of a node being in a state of behavior, and the relationship between nodes connected by edges. The initial probability of a node i to be in a state of behavior xᵢ, is called the prior, denoted by φᵢ(xᵢ). In the context of the belief computation for a graph with visitors and domains as nodes, the states of behavior assumed by nodes in the graph can be a high affinity for an advertisement or a low affinity for an advertisement. Another factor that may be involved in applying belief propagation is expressed by the relationship between two nodes i and j, also called the edge potential. The edge potential represents the probability of j being in a state of behavior xⱼ, given that the state of behavior of i is xᵢ, and vice versa. It is denoted by ψᵢⱼ(xᵢ,xⱼ).

In a graphical model with nodes connected to each other through edges, the computation of a belief can be dependent upon the messages passed over directed edges. A message from i to j which estimates node i's evaluation of node j being in a particular state of behavior (xⱼ), depends on the prior for node i, the edge potential for i and j, and the message inputs that i obtains from all its neighbors (excluding j). Mathematically, the message may be defined as:

$${m}_{ij} ( {x}_{j} ) = {\sum }_{{x}_{i} ∈ {S}_{i}} {φ}_{i} ( {x}_{i} ) {ψ}_{ij} ( {x}_{i} , {x}_{j} ) {\prod }_{k ∈ N ( i ) \backslash j}^{ } {m}_{ki} ( {x}_{i} ) \qquad ( 2 )$$

where N(i) represents the neighbors of node i, and Sᵢ represents the set of all states of behavior that node i can be in. Each message mᵢⱼ gets updated over every iteration and the iterations may stop when messages (e.g., all messages) converge (e.g., the messages do not change significantly when compared to the previous iteration). The messages may be normalized such that Σₓ_{ᵢ}_{εS}_{ⱼ}mₖᵢ(xᵢ)=1. Such normalization of messages may prevent underflow.

Belief propagation can be applied during operation of the number of visitors and the number of domains. The graph can be updated during operation of the number of visitors and the number of domains. For example, as a visitor visits a first and a second domain, the graph can be updated.

At 350, the process 340 can determine a set of scores for a first advertisement. The set of scores for a first advertisement can include computing a belief whether each of the number of nodes is in a particular state of behavior based on the marginal probability estimation. For example, the particular state of behavior can be one of a high affinity to the advertisement, a low affinity to the advertisement, or an intermediate affinity, for example. The messages from the converged (e.g., final) iteration of the belief propagation may be used for computing beliefs through the equation

$${b}_{i} ( {x}_{i} ) = C φ ( {x}_{i} ) {\prod }_{k ∈ N ( i )} {m}_{ki} ( {x}_{i} ) \qquad ( 3 )$$

where C denotes the normalization constant (that is, ensuring Σₓ_{ᵢ}_{εS}_{ᵢ}bᵢ(xᵢ)=1). In this context of assigning an advertisement, the belief value such as bᵢ(xᵢ)=0.6 means that the node i has a 60 percent chance of being associated and/or related to the advertisement.

In some examples of the present disclosure, the set of scores can be calculated with the spreading function using a transfer matrix input. A transfer matrix can estimate a state of behavior of one of the number of domains given a state of behavior of a neighboring one of the number of visitors and/or estimate a state of behavior of a neighboring one of the number of visitors given the state of behavior of one of the number of domains. The transfer matrix input can be established before the spreading function is applied. Table 1 shows an example of a transfer matrix.

TABLE 1
Example Transfer Matrix

Xⱼ

| Xᵢ | Low Affinity | High Affinity |
|---|---|---|
| Low Affinity | A | A′ |
| High Affinity | B′ | B |

For example, a transfer matrix can include a node i and node j that have an edge there between. Given a visitor (e.g., i), if it is assumed to have a low affinity, then the domain (e.g., j) the visitor visits (represented as a graph edge) may be considered to have a low affinity to the advertisement with a probability of A (e.g., 0.51). If the visitor is assumed to have a low affinity, the domain the visitor visits may be considered to have a high affinity with a probability of A′, where A′ is less than A (e.g., in some instances, 1−A, where A>0.5). If the visitor is assumed to have a high affinity, then the domain the visitor visits may be considered to have a high affinity with a probability of B (e.g., 0.51). If the visitor is assumed to have a high affinity, then the domain the visitor visits may be considered to have a low affinity with a probability of B′, where B′ is less than B (e.g., in some instances, 1−B, where B>0.50). In some examples, A and B can be equal to 0.51 and A′ and B′ can be equal to 0.49. Analogous inferences can be made for the state of behavior of a visitor based on the state of behavior of the domain. Thus, the transfer matrix (e.g., Table 1) can symmetrically estimate the behavior of a domain, given a visitor, and vice versa.

For example, external information can indicate that a domain is associated to an advertisement and can be used in a transfer matrix (e.g., Table 1). For instance, the advertisement can be for sports equipment and the domain, based on external information, can be known to a sports related domain; thereby, the domain can be assumed to have a high affinity to the advertisement. A visitor that visits the domain may have a low affinity with a probability of B′ and a high affinity with a probability of B, wherein B′ is less than B. Thereby, if it is known that a domain is a sports site, a visitor that visits the sports site has a higher likelihood of being a sports fan and a higher likelihood of having a high affinity to a sports related advertisement.

In some examples of the present disclosure, a transfer matrix input can include a function of the distance between a visitor and a location. For example, the function of a distance can include the visitor being within a threshold distance (e.g., one mile) of a location (e.g., a store associated with the advertisement, a promotional location, and the location of the advertiser). For instance, a visitor i (e.g., first visitor) that is within a threshold distance of a location can be assumed to have a higher affinity toward the advertisement than a visitor (e.g., second visitor) that is not within the threshold distance. A domain j that the visitor i visits can be considered to have a high affinity B and a low affinity B′, wherein B′ is less than B.

A message value can be sensitive to the choice of the transfer matrix input. For high degree nodes, the outgoing message can converge to specific elements of the transfer matrix input. Other example values for A, A′, B, and B′ can include A=0.75, A′=0.25, B=0.51, and B′=0.49. With respect to these values in the transfer matrix, performance in terms of detection rates and corresponding false positive rates may be relatively the same as for the previous example. However, the convergence rate can be approximately three times faster and the performance for even initial iterations can be very close to that of converging iterations.

Priors can be assigned and the transfer matrix input can be established before belief propagation is applied to compute a belief whether each node is in a particular state of behavior (e.g., a reputation of each node). The reputation can be inferred through message passing. The reputation of each node is the marginal probability estimated through belief propagation and is used to label a node (e.g., as either associated or not associated to an advertisement). Since an outgoing message from a node is dependent on messages sent from its neighbors, equation (3) for a large number of neighbors can lead to underflow. To counter such a problem, a data type for storing extremely small decimal values can be used in addition to normalizing messages.

Belief propagation can be iteratively applied until the messages (e.g., all of the messages) converge. A converged message mᵢⱼ can outline i's estimate of j being in a state of behavior, and that estimate can reach an equilibrium that does not change considerably over time. Once the messages have converged, the beliefs can be computed using equation (3). The beliefs, when normalized, can indicate the relative reputation of the nodes (e.g., from 0.0 to 1.0). A number of thresholds can be selected to designate the reputation of each of the nodes as associated with an advertisement, not associated with an advertisement, or otherwise for given values of the beliefs.

At 352, the set of scores for the advertisement (e.g., the first advertisement) can be stored in a database. The database can include an event database. The database can include a plurality of advertisements, each of the plurality of advertisements associated with a calculated set of visitor scores and domain scores (e.g. each of the plurality of advertisement being associated with a graph). In some examples of the present disclosure, a domain score and/or a visitor score can be stored in response to the corresponding score exceeding a threshold (e.g., fifty percent and 0.49). For instance, a first domain score for an advertisement can be stored in response to the score being greater than 0.40 and a second domain score for the advertisement can not be stored in response the score being less than 0.40.

In some examples, the advertisement can be assigned to a domain based on a domain score of the domain satisfying a criterion. A criterion can include the highest domain score of the set of domain scores, a highest domain score among a class of domains within the set of domain scores, and a highest domain score of the set of domain scores in addition to a bid-price, for example.

At 354, the calculated set of visitors scores and domain scores for the first advertisement can be compared to a calculated set of visitor scores and domain scores for a second advertisement in a database. For example, the first advertisement and the second advertisement can be initially assigned to a domain. The domain may have a number of advertisements assigned to it and an ad network may need to select one advertisement to display to a live visitor. A live visitor can include a visitor that is currently browsing the domain, for instance. Comparing the calculated sets of the first advertisement and the second advertisement can include comparing the live visitor score and the assigned domain score for each of the first advertisement and the second advertisement. For example, event logs may be received of live visitors. The comparison can include a number of advertisements, for instance.

At 356, the first advertisement can be assigned to the domain among the number of domains in response to a visitor score and the domain score for the first advertisement satisfying a criterion compared to the visitor score and the domain score for the second advertisement. For example, the visitor score can include a live visitor score. Criterion to be satisfied can include, a largest score, a largest score excluding advertisements and/or advertisement classes which have been shown in a threshold time period, a largest score and bid-price, a largest product of score of the advertisement class, an advertisement bid-price, and an estimated click-through-rate of the advertisement, for example.

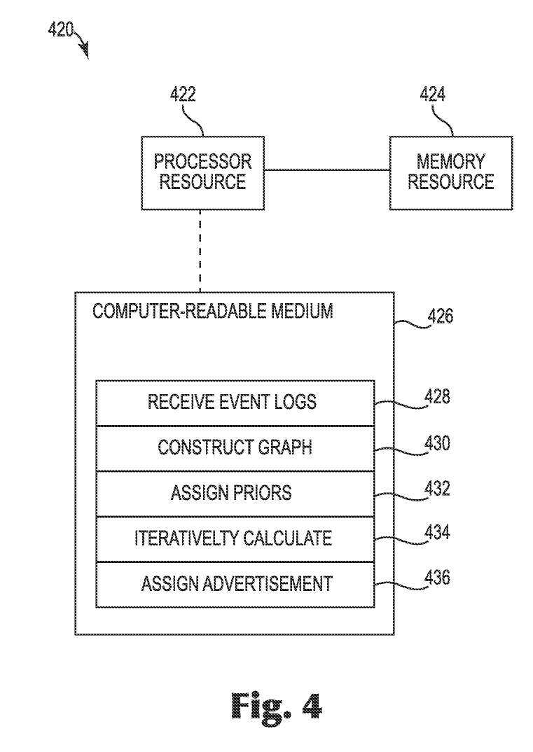

FIG. 4 is a block diagram 420 illustrating a processing resource 422, a memory resource 422, and a computer readable medium 426 according to the present disclosure. The computer readable medium 426 (e.g., a tangible, non-transitory medium) and/or the memory resource 424 can store a set of instructions executable by the processing resource 422 to receive event logs 428 of visits to a number of domains by a number of visitors and construct a graph 430 of a number of nodes representing the number of visitors and the number of domains connected by a number of edges, wherein each edges connects a respective one of the visitors to one of the domains. The instructions can be executed to assign priors 432 to each of the number of nodes for an advertisement and iteratively calculate 434 a set of visitor scores and domain scores for the advertisement using a spreading function. The instructions can be executed to assign the advertisement 436 to a domain among the number of domains based on a domains score of the domain satisfying a criterion.

The methods, techniques, systems, and apparatuses described herein may be implemented in digital electronic circuitry or computer hardware, for example, by executing instructions stored in computer-readable storage media. Apparatuses implementing these techniques may include appropriate input and output devices, a computer processor, and/or a tangible computer-readable storage medium storing instructions for execution by a processor.

A process implementing techniques disclosed herein may be performed by a processor executing instructions stored on a tangible computer-readable storage medium for performing desired functions by operating on input data and generating appropriate output. Suitable processors include, by way of example, both general and special purpose microprocessors. Suitable computer-readable storage devices for storing executable instructions include all forms of non-volatile memory, including, by way of example, semiconductor memory devices, such as Erasable Programmable Read-Only Memory (EPROM), Electrically Erasable Programmable Read-Only Memory (EEPROM), and flash memory devices; magnetic disks such as fixed, floppy, and removable disks; other magnetic media including tape; and optical media such as Compact Discs (CDs) or Digital Video Disks (DVDs). Any of the foregoing may be supplemented by, or incorporated in, specially designed application-specific integrated circuits (ASICs).

Although the operations of the disclosed techniques may be described herein as being performed in a certain order and/or in certain combinations, in some implementations, individual operations may be rearranged in a different order, combined with other operations described herein, and/or eliminated, and the desired results still may be achieved. Similarly, components in the disclosed systems may be combined in a different manner and/or replaced or supplemented by other components and the desired results still may be achieved.

What is claimed:

1. A method for assigning an advertisement, comprising:
constructing a graph of events between a number of visitors and a number of domains;
iteratively calculating a set of domain scores for the advertisement using a spreading function on the graph; and
assigning the advertisement to a domain based on a domain score of the domain, wherein the domain score is among the set of domain scores.

2. The method of claim 1, wherein calculating the set of domain scores further includes:
assigning a first prior to each of the number of domains, wherein a first domain is assigned a higher first prior than a second domain in response to the first domain being associated to the advertisement; and
assigning a second prior to each of the number of visitors.

3. The method of claim 1, wherein calculating the set of domain scores further includes:
assigning a first prior to each of the number of domains; and
assigning a second prior to each of the number of visitors, wherein a first visitor is assigned a higher second prior than a second visitor in response to the first visitor being associated to the advertisement.

4. The method of claim 1, wherein the method further includes receiving event logs containing the events between the number of visitors and the number domains, wherein the events between the number of visitors and the number of domains includes visits to the number of domains by the number of visitors.

5. The method of claim 1, wherein the method further includes:
providing the calculated set of domain scores for the advertisement to an advertiser;
changing a domain score among the set of domain scores in response to an indication from the advertiser; and
recalculating the set of domain scores for the advertisement using the spreading function on the graph.

6. A non-transitory computer-readable medium storing a set of instructions executable by a processing resource to:
receive event logs of visits to a number of domains by a number of visitors;
construct a graph of a number of nodes representing the number of visitors and the number of domains connected by a number of edges, wherein each edge connects a respective one of the visitors to one of the domains;
assign a prior to each of the number of nodes for an advertisement,
iteratively calculate a set of visitor scores and domain scores for the advertisement using a spreading function;
assign the advertisement to a domain among the number of domains based on a domain score of the domain satisfying a criterion.

7. The non-transitory computer-readable medium of claim 6, wherein:
the spreading function is applied via iterative belief propagation by passing a respective message over each of the number of edges in each iteration until values of the messages converge; and
the respective message estimates an evaluation of a first of the number of nodes as to the score of a second of the number of nodes dependent on the prior for the first node and a number of message inputs that the first node has received from other nodes of the number of nodes that share an edge with the first node.

8. The non-transitory computer-readable medium of claim 6, wherein the instructions are executable to:
add a number of initial domain nodes to the graph; and
assign a prior to each of the number of initial domains, wherein the prior assigned to each of the number of initial domains is based on information external to the event dataset indicating an initial likelihood that the plurality of initial nodes are associated with the advertisement.

9. The non-transitory computer-readable medium of claim 6, wherein the instructions are executable to automatically add a number of initial domains to the graph in response to a query of the advertisement.

10. The non-transitory computer-readable medium of claim 8, wherein the instructions are executable to assign a prior to a first visitor that visits an initial domain, wherein the prior assigned to the first visitor is higher than a prior assigned to a second visitor that has not visited the initial domain.

11. The non-transitory computer-readable medium of claim 6, wherein the instructions are executable to:
add a pseudo-domain node to the graph, wherein the pseudo-domain includes a distance from a location;
assign the pseudo-domain node a prior representing an initial likelihood that the pseudo-domain node is associated with the advertisement; and
connect the pseudo-domain node to a visitor node among the number of visitor nodes with an edge in response to the visitor being within a threshold distance from the location.

12. A system for assigning an advertisement, comprising:
a processor;
a memory coupled to the processor and configured to direct the processor to:
store event logs received of visits to a number of domains by a number of visitors in a database;
construct a graph of the visits to the number of domains by the number of visitors from the event logs;
assign a prior to each of the number of domains and the number of visitors for a first advertisement, wherein at least one prior is assigned based on information external to the event logs;
iteratively calculate a set of visitor scores and domain scores for the first advertisement using a spreading function on the graph;
compare the calculated set for the first advertisement to a calculated set for a second advertisement in the database; and
assign the first advertisement to a domain among the number of domains based on the domain score and a visitor score for the first advertisement satisfying a criterion compared to the domain score and the visitor score for the second advertisement.

13. The system of claim 12, wherein the memory is further configured to direct the processor to calculate the set of visitor scores and domain scores for the first advertisement using the spreading function, wherein the spreading function includes a transfer matrix input.

14. The system of claim 13, wherein the memory is further configured to direct the processor to input, into the spreading function, a function of the distance between a visitor and a location as the transfer matrix input.

15. The system of claim 12, wherein the memory is further configured to direct the processor to store at least one of a domain score corresponding to a domain among the number of domains in response to the domain score exceeding a threshold and a visitor score corresponding to a visitor among the number of visitors in response to the visitor score exceeding a threshold.
